(19) United States
(12) Patent Application Publication
(10) Pub. No.: US 2003/0110116 A1
(43) Pub. Date: Jun. 12, 2003

(54) Money saving service method and money saving service apparatus

(76) Inventor: Hiroyuki Inubushi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/350,265

(22) Filed: Jan. 24, 2003

Related U.S. Application Data
(63) Continuation of application No. PCT/JP01/06507, filed on Jul. 27, 2001.

(30) Foreign Application Priority Data
Jul. 27, 2000 (JP) 2000-228006

(51) Int. Cl. G06F 17/60

(52) U.S. Cl. 705/36; 705/7

(57) ABSTRACT

A money-saving evaluation apparatus comprises process input means to which a process value of a plant is input from the plant via a data input apparatus, information input means to which information other than plant data relating to money-saving is input, evaluation formula input/change means for inputting or changing a formula for evaluating money-saving in the plant, money-saving evaluation processing means for performing an evaluation process relating to money-saving of the plant, on the basis of the process value, the information other than the plant data and the input or change of the evaluation formula, and output means for outputting an evaluation result to an output apparatus.

### CROSS-REFERENCE TO RELATED APPLICATIONS

This is a Continuation Application of PCT Application No. PCT/JP01/06507, filed Jul. 27, 2001, which was not published under PCT Article 21(2) in English.

This application is based upon and claims the benefit of priority from the prior Japanese Patent Application No. 2000-228006, filed Jul. 27, 2000, the entire contents of which are incorporated herein by reference.

### BACKGROUND OF THE INVENTION

1. Field of the Invention

The present invention provides a service apparatus and a service method relating to money saving effects associated with plants.

In this specification, “money-saving” is defined as “saving a cost that is constantly incurred”. The word “energy-saving” means to save energy, while “money-saving” is defined as above. There is a case where “energy-saving” is achieved but “money-saving” is not achieved. For example, assume that an entrepreneur has installed equipment for reducing energy. In such a case, the cost may increase, contrary to his/her intention to reduce the cost. By contrast, “money-saving” is a concept that pays attention to money from the beginning. This is a novel idea that negates a fixed concept that “energy-saving=money-saving.”In this specification, “plant” means any kind of plant. In particular, in this specification, a private-use electric power plant (hereinafter “private power plant”) will be described by way of example.

The term “equipment” refers to various equipment constituting various kinds of plants, which are typically a power station, a substation, and a factory. The term “equipment” includes not only general equipment, but also various structural elements of plants such as devices attached to such equipment and various devices included in such equipment. Furthermore, “equipment” includes not only structural elements of plants, but also all structural elements, such as household electric devices and waterworks, which permit monitoring of their states and process amounts by means of electric signals, optical signals, etc.

The term “communication network” includes various kinds of networks that enable communication. In normal cases, it is assumed to use a wide-area network such as the Internet.

The term “information specifying a user” covers various kinds of information that can specify a user. It includes inherent information of a user, such as a name, an appellation, an address and a telephone number.

The term “service information” refers to information relating to services to be provided to a user, such as diagnosis, analysis, preparation of slips and forms, and display/alteration of collected data relating to equipment. It includes various information to be used for services and information necessary for executing services.

The term “data collecting apparatus” refers to all apparatus having functions of inputting and transmitting data. It does not matter whether this apparatus automatically performs data input or performs data input through, e.g. key input from the outside. Accordingly, terminals are included in “data collecting apparatus” if they have such functions.

The phrase “storage on a user-by-user basis” means that user-related information is stored in a mutually associated fashion such that when a user has been specified, information that specifies the user and service information to be provided to the user, for instance, can be extracted. It is not necessary that information is sorted according to respective users.

The term “saving” means permanent saving and temporary saving in a volatile memory, etc.

The term “data server” generally refers to servers handling various data.

2. Description of the Related Art

FIG. 1 shows a conventional plant and a monitoring apparatus thereof. In FIG. 1, process values of a plant 81 are input to a process input section 83 of a plant monitoring apparatus 83 via a data input apparatus 82. The information input to the process input section 83 is processed in a plant monitoring processing section 85. The processed information is output to a CRT 87 or a printer 88. Thus, the condition of the plant 81 is told to the operator. This apparatus, in principle, does not process economic indices (e.g. fuel cost, power generation cost) in a utility generation plant or an industry-owned plant.

An apparatus for processing economic indices is, for example, an economy operation apparatus that is placed on an upper level of the plant monitoring apparatus.

This apparatus, however, is not an apparatus that reduces a regularly incurred cost. This apparatus does not take measures, such as money-saving measures, for the plant. In short, this apparatus is an apparatus that performs economic evaluation at the time of operating the plant under current conditions, without changing operational conditions, etc.

On the other hand, there is known a business called ESCO (Energy Service Company). The ESCO business came from the U.S. and handles money-saving business for buildings and factories.

The ESCO business owner performs energy diagnosis in a building/factory that is an object of business, and provides proposals for energy saving. When energy-saving has successfully been achieved by carrying out the proposals, the energy-saved cost is divided by the client and the ESCO business owner.

This business has four features:

(1) All expenses of the ESCO business are covered by the energy-saving.

(2) The ESCO business owner guarantees a cost reduction amount in an initial plan.

(3) Such services as diagnosis, planning, funding, construction and operational management are provided.

(4) After the business is started, the measurement of the effect and the operational management are conducted.

In Japan, the ESCO has drawn attention as a new promising energy-saving business.

In the meantime, the money-saving business for plants is generally classified into a consultation portion relating to money-saving for plants, and a solution portion for executing items of money-saving, which have been found by the consultation.

In this specification, these businesses are defined as “plant consultation & solution” business. For the purpose of simplicity, this business is referred to as PLACS (PLAnt Consultation & Solution) business. The ESCO business and the PLACS business are mainly different in the following points:

(1) The ESCO business pays attention only to energy and energy-saving, while the PLACS business pays attention to money-saving as well as energy. (Money-saving measures include software-based measures, such as alterations of operations, hardware-based measures, such as addition/change of pipes, and combinations of software-based and hardware-based measures.)

(2) The ESCO business is directed to buildings and factories. The PLACS business is directed to only factories, and more particularly to plants.

As has been described above, the PLACS business is a development of the ESCO business and is a new business.

In general, there are two cases where a money-saving measure is carried out for plants to find an evaluation amount of the measure.

(1) Evaluation information about the money-saving is definite, and a money-saving evaluation amount is almost reliable.

For example, when new power generation equipment has been added to a plant, the amount of power purchased from a power company decreases while the cost for power generation increases. In this case, the money-saving effect can be calculated by supposing “if the amount of power to be purchased was ‘purchased from a power company’”.

(2) Evaluation information about the money-saving is not necessarily definite, and hence a money-saving evaluation amount cannot be calculated or can be calculated only approximately.

Generally speaking, the latter case is more frequent. For example, if blades of a turbine generator are replaced, the total efficiency of the plant increases and money-saving is achieved.

However, in this case, after the blades were replaced, the power generation cost in a case where the blades were not replaced is unknown. Hence, it is not possible to definitely say “some significant money-saving effect was achieved.” Since the conditions of a generator load and a thermal load have varied, it is difficult to show a definite amount of money in consideration of these conditions.

This will now be described in an easy-to-understand manner, referring to a figurative case. Assume that an additive for enhancing fuel consumption was mixed to gasoline for an automobile. If the fuel consumption at a time point one month before the mixing and the fuel consumption at a time point one month after the mixing are compared, the latter is better. However, if the condition of driving differs between the time point one month before the mixing and the time point one month after the mixing, the fuel consumption varies according to the condition of driving. For example, assume that the driving condition was normal at the time point one month before the mixing, and that at the time point one month after the mixing the automobile ran a long distance in a traffic jam, the air-conditioner was continuously operated and moreover the automobile ran along mountain roads. In this case, it is unclear how the mixing of the additive contributed to the enhancement of the fuel consumption.

In summary, since the condition of the plant varies due to “load” as mentioned above, it is difficult, in fact, to say something definite. Thus, in promoting the PALCS business, there is a problem that the apparatus and method have not been established.

In short, there are the following problems.

Even in the above case (1), there is no apparatus that calculates the money-saving evaluation amount according to the condition of the plant. There is no method either.

In the above case (2), there is no apparatus or method that calculates the money-saving evaluation amount.

### BRIEF SUMMARY OF THE INVENTION

The present invention aims at providing an apparatus and a method for calculating a money-saving evaluation amount, as desired, according to the condition of a plant, and an apparatus and a method for a money-saving evaluation amount.

According to a first aspect of the present invention, there is provided a money-saving evaluation apparatus characterized by comprising: process input means to which a process value of a plant is input from the plant via a data input apparatus; information input means to which information other than plant data relating to money-saving is input; evaluation formula input/change means for inputting or changing a formula for evaluating money-saving in the plant; money-saving evaluation processing means for performing an evaluation process relating to money-saving of the plant, on the basis of the process value, the information other than the plant data and the input or change of the evaluation formula; and output means for outputting an evaluation result to an output apparatus.

According to a second aspect of the invention, in an evaluation method relating to money-saving for a plant, there is provided a money-saving evaluation method characterized in that in a first step, a formula for evaluating money-saving is adjusted between a client and a business owner and input to money-saving evaluation processing means for performing money-saving evaluation based on predetermined evaluation information, and in a second step, a money-saving amount is calculated within a predetermined time period using the money-saving evaluation means on the basis of plant data and information other than the plant data relating to money-saving.

According to a third aspect of the invention, there is provided a money-saving evaluation apparatus, wherein one of twin plants X and Y capable of obtaining the same electric load and the same thermal load is subjected to a money-saving measure and the other plant is not subjected to a money-saving measure, characterized by comprising: process input means to which a process value of each of the plants X and Y is input from the plant via a data input apparatus; information input means to which information other than plant data relating to money-saving is input; evaluation formula input/change means for inputting or changing information for evaluating money-saving in the plant; money-saving evaluation processing means for obtaining a money-saving evaluation result by subtracting, in general cases, a plant running cost of the plant subjected to the money-saving measure from a plant running cost of the plant not subjected to the money-saving measure, on the basis of the process value, the information other than the plant data and the input or change of the evaluation information; and output means for outputting an evaluation result to an output apparatus.

According to a fourth aspect of the invention, in an evaluation method relating to money-saving for a plant, there is provided a money-saving evaluation method characterized by comprising: a first step wherein twin plants X and Y capable of obtaining the same electric load and the same thermal load are found in order to evaluate an effect of a money-saving measure, one of the plants being subjected to a money-saving measure while the other plant being not subjected to a money-saving measure; and a second step following the first step, wherein with use of a money-saving evaluation apparatus for receiving data of the twin plants and performing money-saving evaluation, a money-saving amount is calculated by subtracting, in general cases, a plant running cost of the plant subjected to the money-saving measure from a plant running cost of the plant not subjected to the money-saving measure.

According to a fifth aspect of the invention, in a given evaluation method relating to money-saving for a plant, there is provided a money-saving evaluation method characterized by comprising: a first step wherein a money-saving evaluation method for a given plant is verified on an actual plant that is evaluated by an evaluation method using data of twin plants; and a second step following the first step, wherein evaluation information of a money-saving evaluation apparatus is readjusted on the basis of a result of the verification.

According to a sixth aspect of the invention, there is provided a money-saving evaluation apparatus for evaluating money-saving based on predetermined evaluation information, the money-saving evaluation apparatus having data accumulation means characterized by accumulating a process value and information other than plant data.

According to a seventh aspect of the invention, there is provided a money-saving evaluation apparatus for evaluating money-saving based on predetermined evaluation information, characterized by comprising a first communication apparatus disposed on a plant side, a second communication apparatus disposed on a remote side, a communication line connecting the first and second communication apparatuses, and means for cooperating with a remote-enabled apparatus disposed on the remote side.

According to an eighth aspect of the invention, there is provided a money-saving evaluation apparatus for evaluating money-saving based on predetermined evaluation information, characterized by comprising means for calculating a money-saving effect amount at predetermined intervals as a money-saving evaluation result, and output means for outputting a report on the money-saving effect amount.

According to a ninth aspect of the invention, there is provided a money-saving service providing method for subjecting a client's plant to a money-saving measure and providing money-saving effect information to the client, characterized by comprising: a step of providing a web server that manages information; a step of storing money-saving effect information in the web server; and a step wherein at least one of the client and a money-saving service provider inspects information in the web server. In this invention, the money-saving service providing method is characterized by further comprising a step of displaying a money-saving effect amount obtained at predetermined intervals as a money-saving evaluation result. In addition, the money-saving service providing method is characterized in that the step of inspecting the information of the web server further includes a step of performing communication between the client and the money-saving service provider, and a step of storing a result of the communication.

According to a tenth aspect of the invention, there is provided a money-saving service providing method for subjecting a client's plant to a money-saving measure and providing money-saving effect information to the client, characterized by comprising: a step of providing a web server that manages information; and a step of prompting the client to input an ID and a password when the client inspects a web page on the web server, in order to permit only a pre-registered client to inspect the web page.

According to an eleventh aspect of the invention, there is provided a money-saving service providing method for subjecting a client's plant to a money-saving measure and providing money-saving effect information to the client, characterized by comprising: a step of storing money-saving evaluation information for calculating a money-saving effect on the basis of pre-measure cost information and post-measure cost information; a step of storing input pre-measure cost information; a step of receiving and storing plant data sent from a transmission apparatus that collects the client's post-measure plant data; a step of calculating the post-measure cost information using the stored plant data; a step of calculating a money-saving effect on the basis of the calculated post-measure cost information, the stored pre-measure cost information and the money-saving evaluation information; and a step of providing the client with the money-saving effect information based on the calculated money-saving effect.

According to a twelfth aspect of the invention, there is provided a money-saving service providing method for subjecting a client's plant to a money-saving measure and providing money-saving effect information to the client, characterized by comprising: a step of storing money-saving evaluation information for calculating a money-saving effect on the basis of pre-measure cost information and post-measure cost information; a step of prompting the client to input confirmation by presenting confirmation information relating to the money-saving evaluation information; a step of subjecting the client's plant to a money-saving measure on condition that the confirmation has been input; a step of storing input pre-measure cost information; a step of receiving and storing plant data sent from a transmission apparatus that collects the client's post-measure plant data; a step of calculating the post-measure cost information using the stored plant data; a step of calculating a money-saving effect on the basis of the calculated post-measure cost information, the stored pre-measure cost information and the money-saving evaluation information; and a step of providing the client with the money-saving effect information based on the calculated money-saving effect.

According to a 13th aspect of the invention, there is provided a money-saving service providing method for subjecting a client's plant to a money-saving measure and providing money-saving effect information to the client, characterized by comprising: a step of storing money-saving evaluation information for calculating a money-saving effect on the basis of pre-measure cost information and post-measure cost information; a step of storing a pre-measure cost calculation condition for calculating pre-measure cost information based on post-measure plant data; a step of prompting the client to input confirmation by presenting confirmation information relating to the money-saving evaluation information and the pre-measure cost calculation condition; a step of receiving and storing, after the input of the confirmation, plant data sent from a transmission apparatus that collects the client's post-measure plant data; a step of calculating the post-measure cost information using the stored plant is data, and calculating pre-measure cost information using the data and the pre-measure cost calculation condition; a step of calculating a money-saving effect on the basis of the calculated post-measure cost information, the pre-measure cost information and the money-saving evaluation information; and a step of providing the client with the money-saving effect information based on the calculated money-saving effect.

In each of the above money-saving service providing methods,

(1) there is provided a step of obtaining pre-measure cost information, as the pre-measure cost information, by operating the plant in a pre-measure state for a predetermined time period,

(3) there are provided a step of enabling input of change request information with respect to at least one of the money-saving evaluation information and the pre-measure cost calculation condition, when the confirmation information is presented to prompt the input of the confirmation; and a step of changing the stored information on the basis of the change request information when the client has input the change request information, and

(4) there is provided a step of billing, when a positive effect is obtained as a result of the calculation of the money-saving effect, in accordance with the effect.

According to a 14th aspect of the invention, there is provided a money-saving service providing method for subjecting a client's plant to a money-saving measure and providing money-saving effect information to the client, characterized by comprising: a step of sending plant data to a network; a step of inputting the plant data to a web server and processing/outputting money-saving evaluation; a step of providing a network terminal that displays a result processed by the web server; and a step of performing input/change of information and an evaluation formula through the network terminal.

### BRIEF DESCRIPTION OF THE SEVERAL VIEWS OF THE DRAWING

FIG. 1 shows a conventional plant monitoring apparatus;

FIG. 2 shows the structure of a first embodiment of a money-saving evaluation apparatus according to the present invention;

FIG. 3 illustrates an example of an evaluation procedure in the money-saving evaluation apparatus according to the invention;

FIG. 4 illustrates a procedure for altering and adjusting an evaluation formula in the money-saving evaluation apparatus according to the invention;

FIG. 5 is a view for explaining another example of the embodiment shown in FIG. 2;

FIG. 6 shows the structure of a second embodiment of the money-saving evaluation apparatus according to the present invention;

FIG. 7 shows the structure of a third embodiment of the money-saving evaluation apparatus according to the present invention;

FIG. 8 shows the structure of a fourth embodiment of the money-saving evaluation apparatus according to the present invention;

FIG. 9 shows an example of an output of the money-saving evaluation apparatus according to the present invention;

FIG. 10 shows a whole system configuration including, as a main part, a money-saving evaluation apparatus according to a fifth embodiment of the present invention;

FIG. 11 shows an example of display of money-saving effect information;

FIG. 12 is a flow chart illustrating a flow in the case of using a network;

FIG. 13 shows an example of a screen for communication;

FIG. 14 shows details of a web server shown in FIG. 10;

FIG. 15 shows an example of display in the case of inputting an ID and a password;

FIG. 16 is a block diagram showing the structure of an information processing system according to the first embodiment of the invention;

FIG. 17 is a flow chart schematically showing a plant data management procedure by a plant data server of a data center according to the first embodiment;

FIG. 18 is a flow chart schematically showing a plant data storing procedure in a sixth embodiment; and

FIG. 19 is a flow chart schematically showing a plant data search/display procedure up to the display output of plant data on a business terminal in the sixth embodiment.

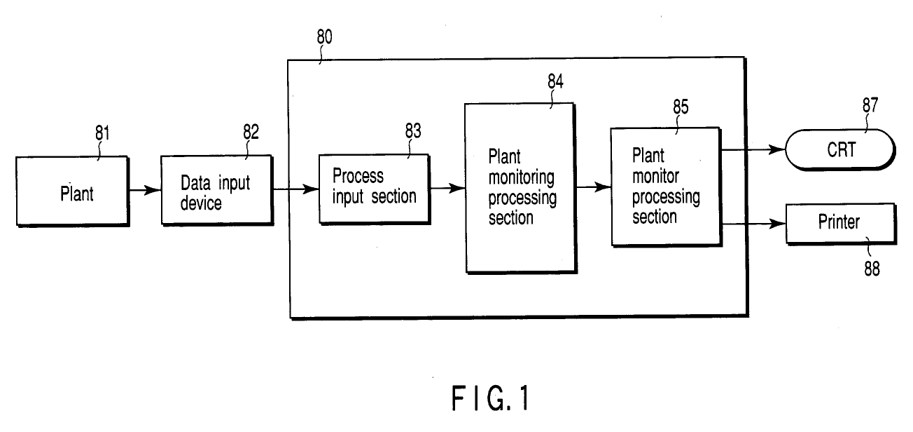

### DETAILED DESCRIPTION OF THE INVENTION

Embodiments of the present invention will now be described.

<First Embodiment>

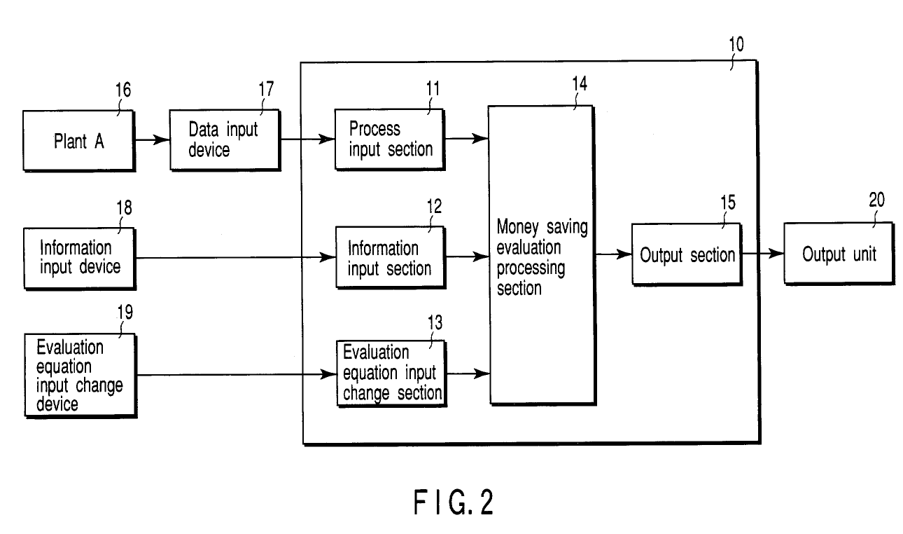

FIG. 2 shows an entire system including a money-saving evaluation apparatus according to a first embodiment of the present invention. The apparatus according to the first embodiment processes an electricity sales amount in, in particular, a private generator possessing company and a commercial-scale utility consumer in the evaluation of money-saving.

In FIG. 2, a money-saving evaluation apparatus 10 comprises a process input section 11 (process input means), an information input apparatus 12 (information input means), an evaluation formula input/change apparatus 13 (evaluation formula input/change means), a money-saving evaluation processing section 14 (money-saving evaluation processing means) and an output section 15 (output means). The process input section 11 inputs a process value. The information input apparatus 12 inputs information other than plant data relating to money-saving. The evaluation formula input/change apparatus 13 inputs or changes information for evaluating money-saving. The money-saving evaluation processing section 14 performs an evaluation process relating to money-saving of a plant, on the basis of the process value, the information other than plant data, and the input or change of the evaluation formula. The output section 15 outputs a result of the evaluation process performed by the money-saving evaluation processing section 14.

The process value of the plant is input from a plant 16 to the process input section 11 of money-saving evaluation apparatus 10 via a data input apparatus 17. The output from the process input section 11 is input to the money-saving evaluation processing section 14.

On the other hand, the information other than the plant data relating to the money-saving is input from to an information input apparatus 18 to the information input section 12 of money-saving evaluation apparatus 10. The output from the information input section 12 is also input to the money-saving evaluation processing section 14.

An evaluation formula (to be described later) for evaluating the effect of money-saving is input from an evaluation formula input/change apparatus 19 to an evaluation formula input/change section 13 of money-saving evaluation apparatus 10. Alternatively, a previously input evaluation formula is changed and input later. The output from the evaluation formula input/change section 13 is input to the money-saving evaluation processing section 14.

The money-saving evaluation processing section 14 receives the outputs from the process input section 11, information input section 12 and evaluation formula input/change section 13 and performs a money-saving effect evaluation process on the basis of a predetermined evaluation formula. The money-saving evaluation processing section 14 outputs the result of the evaluation process to the output section 15. The output section 15 outputs the evaluation information to an output apparatus 20, such as a display or a printer, which is connected to the money-saving evaluation apparatus 10.

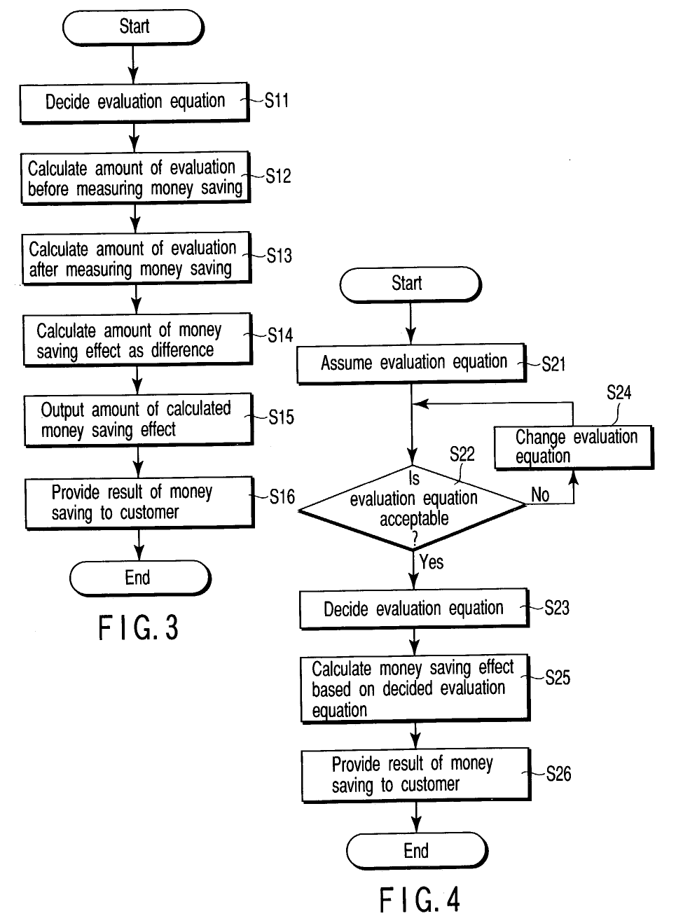

The operation of the money-saving evaluation processing apparatus 10 will now be described with reference to FIG. 3. In step S11, an evaluation formula to be used in the money-saving evaluation processing section 14 is determined. This evaluation formula is input in advance from the evaluation formula input/change apparatus 19 via the evaluation formula input/change section 13.

In step S12, data relating to the plant 16 that is obtained before the money-saving measure is taken is input to the money-saving evaluation processing section 14 via the data input apparatus 17 and process input section 11. Based on the evaluation formula, an evaluation amount prior to the money-saving measure is calculated. At this time, the information other than the data on the plant 16 is input from the information input apparatus 18 to the money-saving evaluation processing section 14 via the information input section 12.

Next, the plant 16 is set in a state after the money-saving measure. The data on the plant 16 in this state is input to the money-saving evaluation processing section 14 via the data input apparatus 17 and process input section 11. Thus, in step S13, the money-saving evaluation processing section 14 calculates an evaluation amount after the money-saving measure, according to the evaluation formula on the basis of the data after the money-saving measure.

In step S14, a money-saving effect amount is calculated by subtracting the evaluation amount after the money-saving measure from the evaluation amount prior to the money-saving measure.

In step S15, the calculated money-saving effect amount is output to the external output apparatus 20 via the output section 15 and is presented to the client, etc.

The plant 16 in FIG. 2 is an object of evaluation before the money-saving measure and at the same time an object of evaluation after the money-saving measure. From before the money-saving measure, the data of the plant 16 is sampled via the data input apparatus 17. After the money-saving measure, the data is used to find a decrease of a given amount (e.g. power generation cost) and calculates the effect amount.

If the money-saving measure is associated with software such as a change of operation, the effect amount can be evaluated in a relatively short time period. On the other hand, if it is associated with hardware such as replacement of a rotor of a turbine generator, the effect amount can be evaluated after a relatively long time.

The evaluation formula used in evaluating the money-saving effect is uniquely applicable to each money-saving measure. An example of the evaluation formula will now be described, referring to a case of adding new private power equipment to a plant.

In a qualitative aspect, the addition of the private power equipment decreases the amount of power to be purchased from a power company and increases the cost for power generation. In this condition, the money-saving effect can be calculated by supposing “if the amount of power to be purchased was ‘purchased from a power company’”.

For the purpose of simplicity, a description will be given of an example in which the money-saving effect amount is calculated, with attention paid to one day. The amount of the money-saving effect can be given by the following formula:

X=Y−Z

where

X: a money-saving effect amount (yen),

Y: a power purchase amount (yen) for purchase from a power company, which corresponds to the amount of power generated by the private power equipment; and

Z: a private power generation cost (yen).

In general, a private power generation cost is lower than a unit cost of power purchased from a power company. The greater the amount of power obtained by private power generation, the higher the money-saving effect. In fact, steam as well as electricity is supplied in the private power generation, and hence the above formula becomes more complex.

In the money-saving evaluation apparatus 10 of FIG. 2, wherein this evaluation formula is set, the process value of the plant 16 is automatically input to the money-saving evaluation processing section 14 via the data input apparatus 17 and process input section 11. On the other hand, the information other than the plant data is input from the information input apparatus 18 to the money-saving evaluation processing section 14 via the information input section 12. Based on the money-saving evaluation formula input/changed via the evaluation formula input/change section 13 from the evaluation formula input/change apparatus 19, the money-saving evaluation processing section 14 can calculate the evaluation amount relating to the money-saving in the plant 16.

According to the above-described money-saving evaluation apparatus, the money-saving effect of the plant can be measured/evaluated more quantitatively, and carried out exactly. Thus, both the client and the business owner can enjoy merits.

Referring now to FIG. 4, a description will now be given of an embodiment of a method of the invention as applied to the money-saving evaluation processing section 14 in the case where the business owner and client consult and adjust the evaluation formula.

The process value from the process input section 11 and the information other than the plant data from the information input section 12 are input to the money-saving evaluation processing section 14, and the money-saving evaluation amount, i.e. the money-saving effect amount, of the plant is calculated according to the evaluation formula input from the evaluation formula input/change section 13.

In step S21 in FIG. 4, an evaluation formula to be adopted for money-saving evaluation in the money-saving evaluation processing section 14 is once assumed.

In step S22, the business owner consults the client to discuss whether the assumed evaluation formula is proper. If the client accepts the evaluation formula (Yes in step S22), the control goes to step S23 to determine that this evaluation formula is adopted for the money-saving evaluation in the money-saving evaluation processing section 24.

If the assumed evaluation formula is not proper (No in step S22), the evaluation formula is changed in step S24. The business owner consults the client once again for adjustment.

The change of the evaluation formula at this time is effected as follows. The change is instructed from the evaluation formula input/change apparatus 19 to the evaluation formula input/change section 13 of money-saving evaluation apparatus 10. This instruction is input to the money-saving evaluation processing section 14.

If the evaluation formula is still improper, it is changed in step S24 once again, and whether the formula is proper is discussed in step S12.

If the business owner and client agree about the evaluation formula, the control advances to step S23 to determine that this formula is adopted as the money-saving evaluation formula.

In the next step S25, the money-saving evaluation processing section 14 calculates the money-saving effect on the basis of the determined evaluation formula. In step S26, the result obtained by the money-saving evaluation processing section 14 is output to the output apparatus 20 via the output section 15 and is presented to the client. Thus, the evaluation of the money-saving effect is completed.

According to the method illustrated in FIG. 4, the evaluation amount relating to the money-saving of the plant can be calculated on the basis of the evaluation formula adjusted in advance between the client and business owner.

Thereby, the money-saving effect of the plant can be measured/evaluated more quantitatively, and carried out exactly. Thus, both the client and the business owner can enjoy merits. Moreover, since the evaluation formula is adjusted between the client and business owner, the objectiveness is enhanced and the client can feel more assurance.

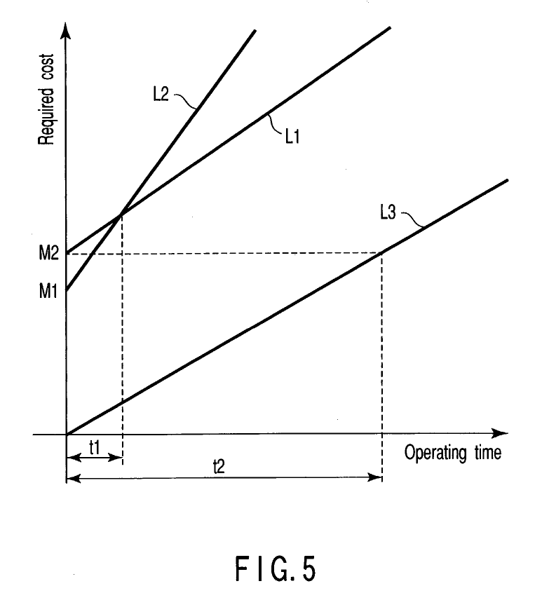

Referring to FIG. 5, an example of the evaluation formula to find a power-saving fee will be described.

An yearly power-saving fee S (yen/year) by virtue of a high-efficiency motor can be calculated by the following formula:

S=(W1−W2)×C×N

where W1 is an input power (kW) of a standard motor, W2 is an input power (kW) of a high-efficiency motor, C is an electric energy fee (yen/kWh), and N is an operating time (h/year).

The electric energy fee, as applied in this case, is a substantive fee in which expenses, such as a basic fee and taxes, are added to an electric energy fee according to a contract demand.

In FIG. 5, the abscissa indicates the operating time, and the ordinate indicates necessary expenses. M1 denotes a purchase price of the standard motor, and M2 denotes a purchase price of the high-efficiency motor. In this case, a straight line L1 indicates the sum of the purchase price of the standard motor and the electric power fee, and a straight line L2 indicates the sum of the purchase price of the high-efficiency motor and the electric power fee.

A straight line L3 indicates a power-saving fee by virtue of the use of the high-efficiency motor.

The following formula expresses the calculation of recovery of the additional price portion of the high-efficiency motor purchase price. A recovery time period t1 of the additional price portion of the high-efficiency motor purchase price, which makes an economic break-even point, can be expressed by

t1 (year)=(M2−M1)/S (yen/year)

where M2 and M1 are purchase prices (yen) of the high-efficiency motor and standard motor, respectively.

In FIG. 5, t2 indicates a time period over which the price of the high-efficiency motor can be recovered by the power-saving fee.

The money-saving evaluation apparatus stores the information for calculating the above-mentioned yearly power-saving fee S as money-saving amount calculation information, the information for calculating the above-mentioned recovery time period t1 as money-saving evaluation information (the sum of the information of the yearly power-saving fee S and the information of the recovery time period t1 may be used as money-saving evaluation information), and the information for calculating a profit of the business owner that can be obtained by multiplying the effective amount S by a predetermined ratio after the passing of the high-efficiency motor price recovery time period t2. After the money-saving measure, the actual values of W2, etc. are input, and the evaluation of the money-saving measure is carried out.

At this time, if the business owner and the client confirm these information items in advance, both parties can conduct business transactions with assurance. In addition, advantageously, the client can estimate the money-saving amount, and the business owner can estimate the profit. Furthermore, a difference between the actual value and the estimate value may be analyzed to correct the stored information. Thereby, business transactions with higher precision can be conducted.

<Second Embodiment>

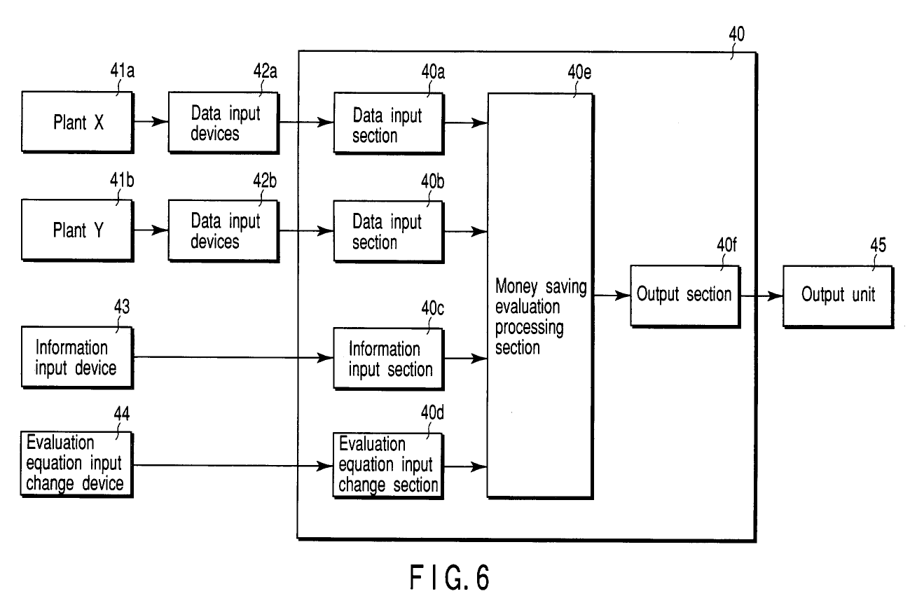

FIG. 6 shows the whole structure of a system including a money-saving evaluation apparatus according to a second embodiment of the present invention.

In FIG. 6, a money-saving evaluation apparatus 40 comprises a data input section 40a, a data input section 40b, an information input section 40c, a data input section 40a, a data input section 40b, an information input section 40c, an evaluation formula input/change section 40d, a money-saving evaluation processing section 40e, and an output section 20f (output means). The evaluation formula input/change section 40d inputs or changes a formula for evaluating money-saving. The money-saving evaluation processing section 40e performs a money-saving evaluation process based on outputs from the data input section 40a and data input section 20b according to the evaluation formula input/changed by the evaluation formula input/change section 40d. The output section 20f (output means) outputs a result of the evaluation process performed in the money-saving evaluation processing section 40e.

Assume that a plant X 41a and a plant Y 41b are twin plants capable of obtaining the same electric load and the same thermal load. One of the plants is subjected to a money-saving measure, and the other is not subjected to a money-saving measure. Plant data from these plants is input to the process input sections 40a and 40b via data input apparatuses 42a and 42b.

Information other than the plant data relating to the money-saving is input from an information input apparatus 43 to the information input section 40c of money-saving apparatus 40. In addition, input/change of the evaluation formula is told from an evaluation formula input/change apparatus 44 to the evaluation formula input/change section 40d of money-saving apparatus 40.

The money-saving evaluation processing section 40e performs money-saving evaluation according to the evaluation formula input from the evaluation formula input/change section 40d on the basis of the process values and information other than the plant data, which have been input from the process input sections 40a, 40b and the information input section 40c. Specifically, a money-saving evaluation result is obtained by subtracting, in general cases, the plant running cost of the plant subjected to the money-saving measure from the plant running cost of the plant not subjected to the money-saving measure.

The result obtained by the money-saving evaluation processing section 40e is output to an output apparatus 45 via the output section 40f.

According to the second embodiment, the evaluation amount relating to the money-saving of the plant can be calculated in a form based on an actual money-saving amount, which is generally considered difficult to achieve. Furthermore, the money-saving effect can be verified and confirmed by a realistic method in an objective manner, which was difficult in the prior art. Thus, both the client and the business owner can enjoy merits.

Besides, the twin plants X and Y capable of obtaining the same electric load and the same thermal load are found, and one of the plants is subjected to a money-saving measure while the other is not subjected to a money-saving measure. Thereby, the objectiveness of evaluation is enhanced, and the client can feel more assurance.

<Third Embodiment>

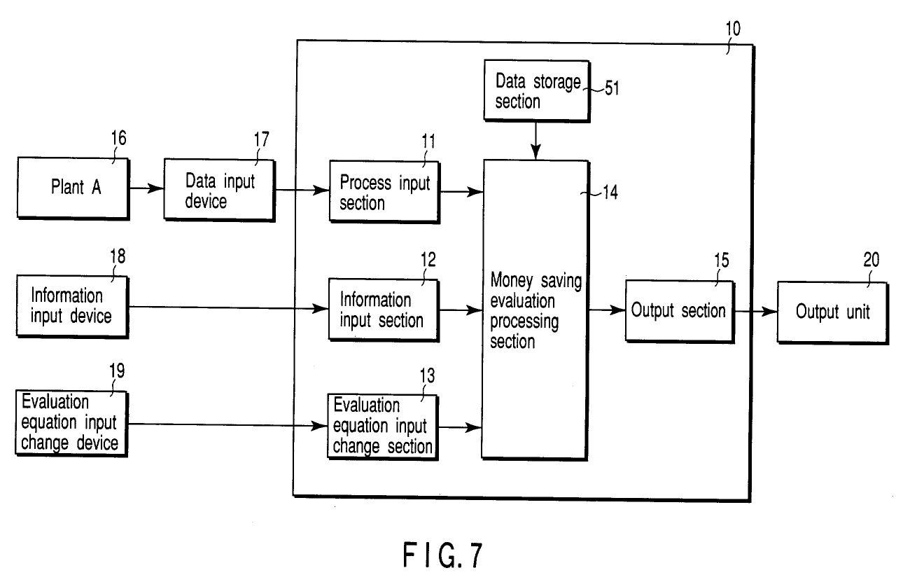

FIG. 7 shows a whole system configuration including, as a main part, a money-saving evaluation apparatus according to a third embodiment of the present invention. In this configuration, a data storage section 51 is added to the structure shown in FIG. 2.

Specifically, a money-saving evaluation apparatus 10 according to the third embodiment differs from the money-saving evaluation apparatus of the first embodiment in that the data storage section 51 that stores process values and information other than plant data is added to the money-saving evaluation apparatus 10.

According to the third embodiment, past data can be stored in the data storage section 51. Thus, a money-saving evaluation amount can be calculated once again on an as-needed basis.

According to the third embodiment, when a new money-saving method has been developed, it can be examined and evaluated in advance on the basis of the stored past data. Furthermore, based on improvement/readjustment of an evaluation formula that is based on actual achievement, the money-saving effect in the time period can be calculated once again. Thus, the client can know a preliminary evaluation result in a quantitative form, and not in a qualitative form. Both the client and business owner can advantageously use the data.

<Fourth Embodiment>

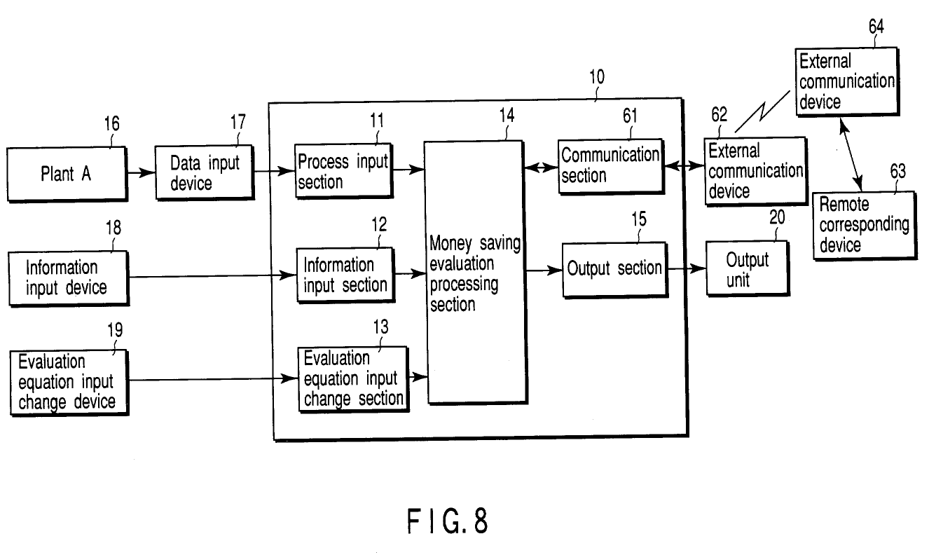

FIG. 8 shows a whole system configuration including, as a main part, a money-saving evaluation apparatus according to a fourth embodiment of the present invention. The structure of the fourth embodiment differs from the structure shown in FIG. 2 in the following respects. The money-saving evaluation apparatus 10 includes a communication section 61, which is connected to an external communication apparatus 62. The communication apparatus 62 can communicate over a communication line with a communication apparatus 64 that is connected to a remote-enabled apparatus 63.

Unlike the money-saving evaluation apparatus of the first embodiment, the money-saving evaluation apparatus 10 according to the fourth embodiment is provided with the communication means (communication section 61 and communication apparatus 62), and the plant-side communication apparatus 62 is connected over the communication line to the remote-side communication apparatus 64, thus enabling cooperation with the remote-enabled apparatus 63.

Accordingly, the money-saving amount can be confirmed from a remote place.

According to the fourth embodiment, the business owner can save a business trip cost and a personnel cost, and can acquire data necessary for evaluation without the need to spend time for movement. Therefore, an evaluation result can be calculated quickly, and the client can advantageously obtain an evaluation result earlier.

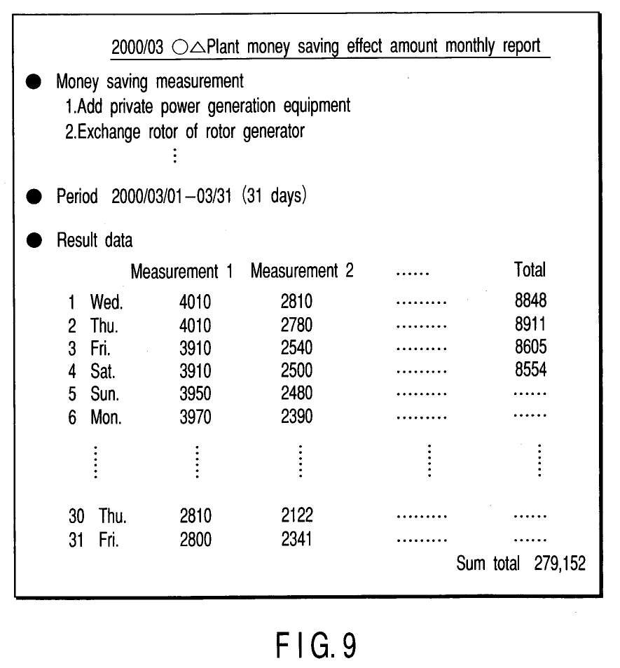

FIG. 9 shows an example of an output of the money-saving evaluation apparatus according to each embodiment of the present invention. This example of output is a monthly report showing detailed daily achievement data on the money-saving effect amount in March 2000. As in this example, the money-saving evaluation result can be output as a money-saving effect amount at regular intervals in the form of a report.

According to the display of output shown in FIG. 9, the money-saving effect amount can be presented in an easy-to-understand form.

If the evaluation result is output at regular intervals, the client can obtain, for example, monthly money-saving effect amounts. The client can advantageously confirm the degree of money-saving effect periodically.

In the present invention, the customer is not limited to a commercial-scale utility customer, and the private generator possessing company may generally be a power supplier.

As has been described above, the present invention has the advantage that the money-saving evaluation result can efficiently be obtained more quantitatively and more reliably, whether the money-saving evaluation formula is definite or not.

<Fifth Embodiment>

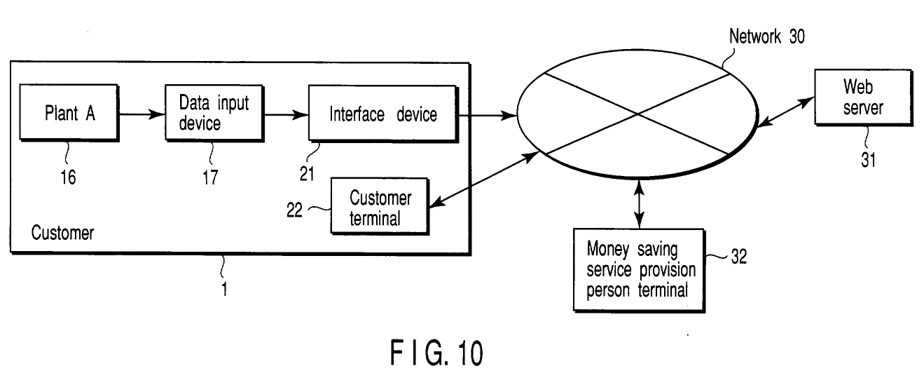

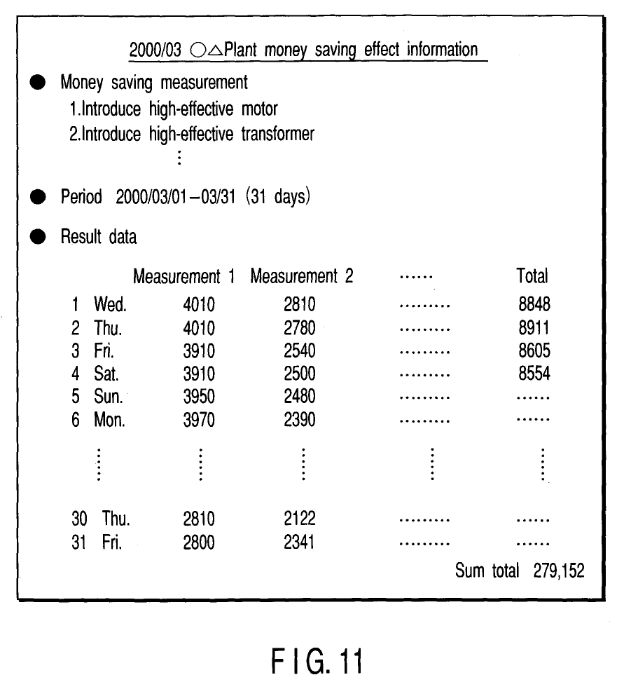

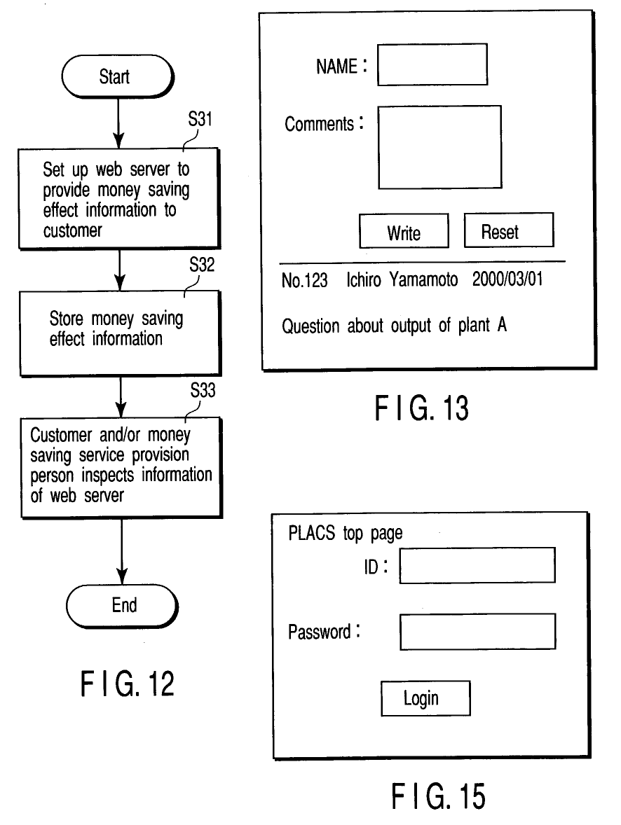

FIG. 10 shows a whole system configuration including, as a main part, a money-saving evaluation apparatus according to a fifth embodiment of the present invention. FIG. 11 shows an example of display of money-saving effect information. FIG. 12 is a flow chart illustrating the operation of the apparatus having the structure as shown in FIG. 10.

Information of the plant 16 is input to an interface apparatus 21 via the data input apparatus 17 (step S31). The interface apparatus 17 is an interface apparatus for sending data to a network 30 (in this example, it is assumed that the Internet is used as a network and thus the network is also referred to as “Internet”). For example, the interface apparatus 21 performs operations of adding a header for distinguishing data and converting data to a packet with a predetermined length, so that the data obtained from the plant 16 can be sent to the Internet 30.

The data sent to the Internet 30 is delivered to a web server 31 that manages information. The web server 31 that has received the data stores the received data as money-saving effect information (step S32).

In addition, the money-saving effect information stored in the web server 31 is displayed on a client's Internet terminal or a money-saving service provider's Internet terminal (i.e. a client terminal 22 and money-saving service provider terminal 32) (step S33). The client and the money-saving service provider can view such information. FIG. 11 shows an example of display of money-saving effect information.

In FIG. 10, the independent web server 31 is connected to the network 31. Alternatively, the interface apparatus 21 may be provided with the function of the web server 31.

According to this embodiment, money-saving services can be provided using the Internet. In particular, the content of the money-saving amount can be displayed on the client side and the money-saving service provider side as the same screen. Thus, the information can smoothly be shared.

The use of the Internet as a communication network can reduce the cost to about 1/100 to 1/1000, compared to the use of a purpose-specific network. Thus, the use of the Internet is advantageous in terms of cost, too. Needless to say, if security is to be kept, an intranet may be used for the Internet.

When information is to be shared via the network 30 as described above, there is a possible case where communication is needed between the client and the money service provider. It is thus preferable to prepare a screen for communication, as shown in FIG. 13, which has a comment window for communication between the client and the money-saving service provider.

In an example of display shown in FIG. 13, the name of a person who writes comments is input to a box “NAME”, and the person clicks a button “WRITE” after having written comments. A button “RESET” on the screen is clicked in order to erase comments written in a box “COMMENT”.

Once comments have been written, the comment number (No. 123), the name (Yamamoto Ichiro) and the date/time of write (Mar. 1, 2000, 11:40) are recorded along with the comments

In this example, the client asks a question about the output of the plant. The money-saving service provider can know the question from the client through this screen and can answer it through the window on the same screen. If the communication content is recorded, it can be used as part of a conference note. Even if either the client or the money-saving service provider is replaced due to a change of personnel, the past communication record is kept. Thus, it is much less possible that confusion occurs to the past record.

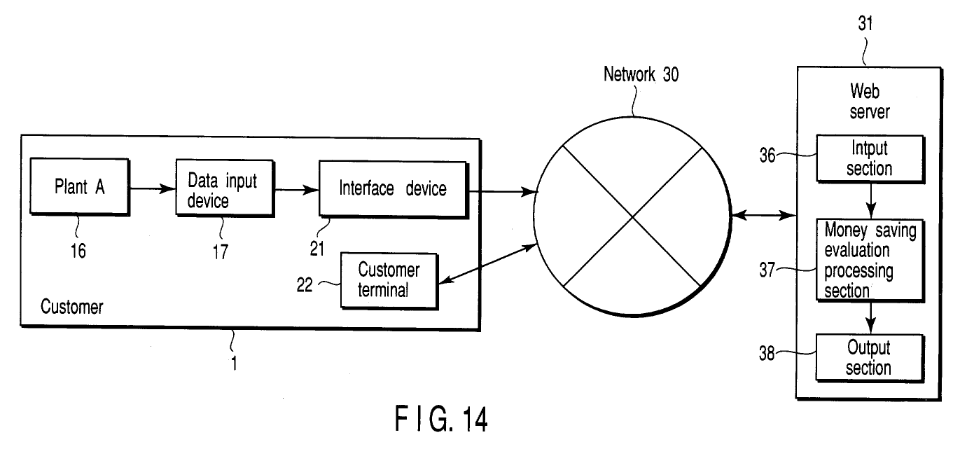

FIG. 14 shows details of the web server shown in FIG. 10. Like FIG. 10, the information of the plant 16 is input to the interface apparatus 21 via the data input apparatus 17.

The data sent from the interface apparatus 21 to the network 30 (Internet or intranet) is input to the web server 31 for managing information.

In the web server 31, an input section 36 receives the data and delivers it to a money-saving evaluation processing section 37. The money-saving evaluation processing section 37 performs a process calculation for money-saving evaluation. A result of the process is sent to an output section 38 and the data is sent to the network 30 once again. The Internet terminal such as the client terminal 22 or money-saving service provider terminal 32 displays data based on the sent data.

If necessary, information input or input/update of the evaluation formula is effected through the Internet terminal and is reflected on the evaluation process in the web server 31.

In this embodiment, it is not preferable in terms of security for a third party, other than the client and the provider, to be able to log in to the web server. Thus, in this embodiment, log-in is performed through a screen on the web page for inputting an ID and a password, as shown in FIG. 15. The ID and password are input and a button “LOG-IN” is selected (for example, double click on the screen) to permit the log-in. If the input ID and password coincide with the pre-registered ID and password, an exclusive-use page associated with the ID can be accessed.

As has been described above, the access to the data in the web server requires the pre-registered ID and password. Therefore, data access by a non-related third party can be prevented.

Furthermore, since the ID is provided, the history of accesses can be checked on an ID-by-ID basis. Where necessary, the fee may be charged.

<Sixth Embodiment>

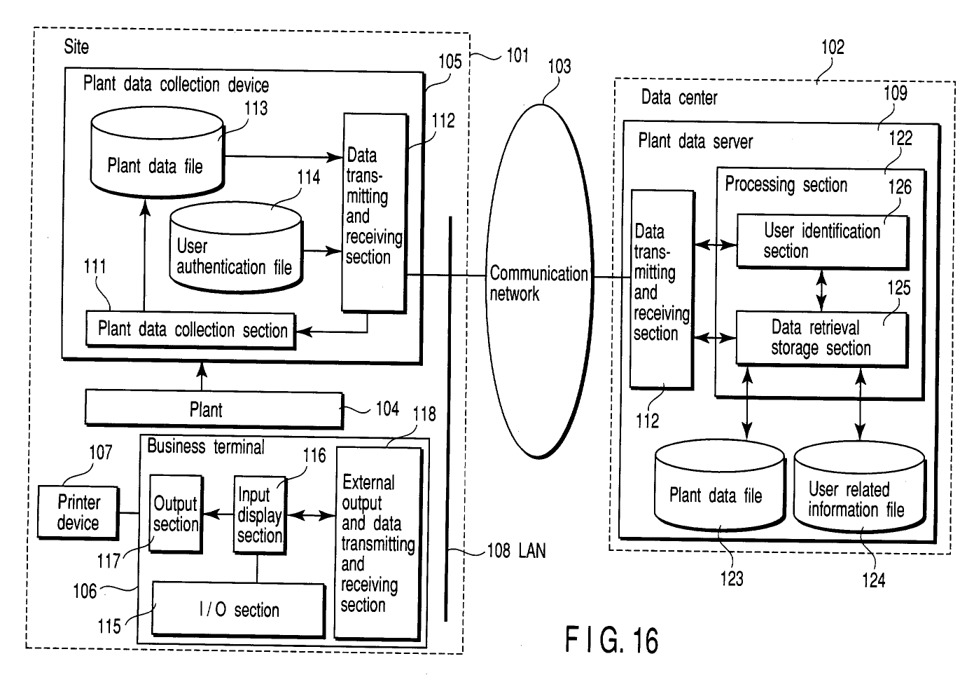

FIG. 16 is a block diagram showing the structure of an information processing system according to a sixth embodiment of the present invention.

As is shown in FIG. 16, the present system is constructed such that each user-side site 101 and a data center 102 are connected via a communication network 103 such as the Internet. Each site 101 comprises a plant data collection apparatus 105 for collecting plant data of a plant 4, a business terminal 106, and a printer apparatus 107 connected thereto. The plant data collection apparatus 105 and business terminal 106 are connected over a LAN 108. The data center 102 comprises a data server 9 for storing and managing plant data sent from each site 101.

More specifically, the plant data collection apparatus 105 comprises a plant data collection section 111, a data transmission/reception section 112, and a plant data file 113 and a user authentication file 114 as data files. The plant data file 113 is a file for temporarily storing each plant data collected by the plant data collection section 111. The user authentication file 114 is a file storing “user authentication” including “user ID” and “apparatus ID” preset for the user and the plant data collection apparatus 105 of the site.

The business terminal 106 comprises an input/output section 115 including an input section such as a keyboard or a mouse and an output section such as display; an input display section 116 for effecting data input/display through the input/output section 115; an output section 117 for external output; and a data transmission/reception section 118.

On the other hand, the plant data server 109 comprises a data transmission/reception section 121, a processing section 122, and a plant data file 123 and a user-related information file 24 as data files. The plant data file 123 is a file for storing and accumulating plant data sent from the plant data collection apparatus 105 of each site 101. The user-related information file is a file for storing user-related information on a user-by-user basis, which includes information relating to user authentication including a user ID and an apparatus ID, and service information to be provided to the user. The processing section 122 comprises a data search storage section 125 for effecting a data search and data storage for the files 123 and 124, and a user identification section 126 for identifying user authentication.

FIG. 16 shows only one site 101 for the purpose of simplicity and clarity. In the actual system, a plurality of sites 101 are connected. In addition, for the purpose of simplicity and clarity, FIG. 16 shows only characteristic parts and functional sections of the present invention as regards the plant data collection apparatus 105, business terminal 106 and plant data server 109. In the actual system, needless to say, there are other parts and functional sections as well as related devices.

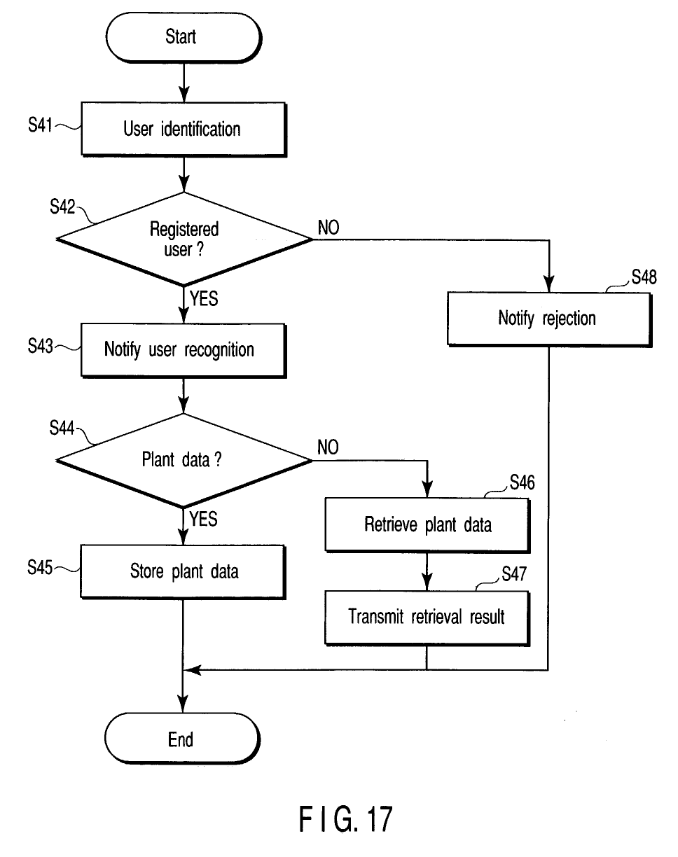

FIG. 17 is a flow chart schematically showing a plant data management procedure by the plant data server 109 of data center 102 in the present system having the above structure. As is shown in FIG. 17, when the plant data is to be managed, the plant data server 109 searches, displays and outputs the stored plant data in response to a request from the user. On the other hand, the plant data server 109 stores and accumulates new plant data each time it has received such new plant data.

In FIG. 17, the plant data server 109 identifies the user authentication including the apparatus ID and user ID sent from the user-side plant data collection apparatus 105 or business terminal 106 (S41). If the registered user is identified (YES in S42), a user recognition notice is issued (S43). If the origin of transmission is the plant data collection apparatus 105 and the transmission content is plant data (YES in S44), the plant data server 109 receives and stores the plant data (S45).

On the other hand, if the origin of transmission is the business terminal 106 and the transmission content is a plant data display request (NO in S44), the plant data is searched in response to the plant data display request (S46) and the search result is sent to the business terminal 106 (S47). If the user is not the registered one (NO in S42), a notice of rejection is sent to the origin of transmission (S48).

The operations of the entire system including the operations of the plant data server 109 will now be described individually for the plant data storing procedure and the plant data search/display procedure.

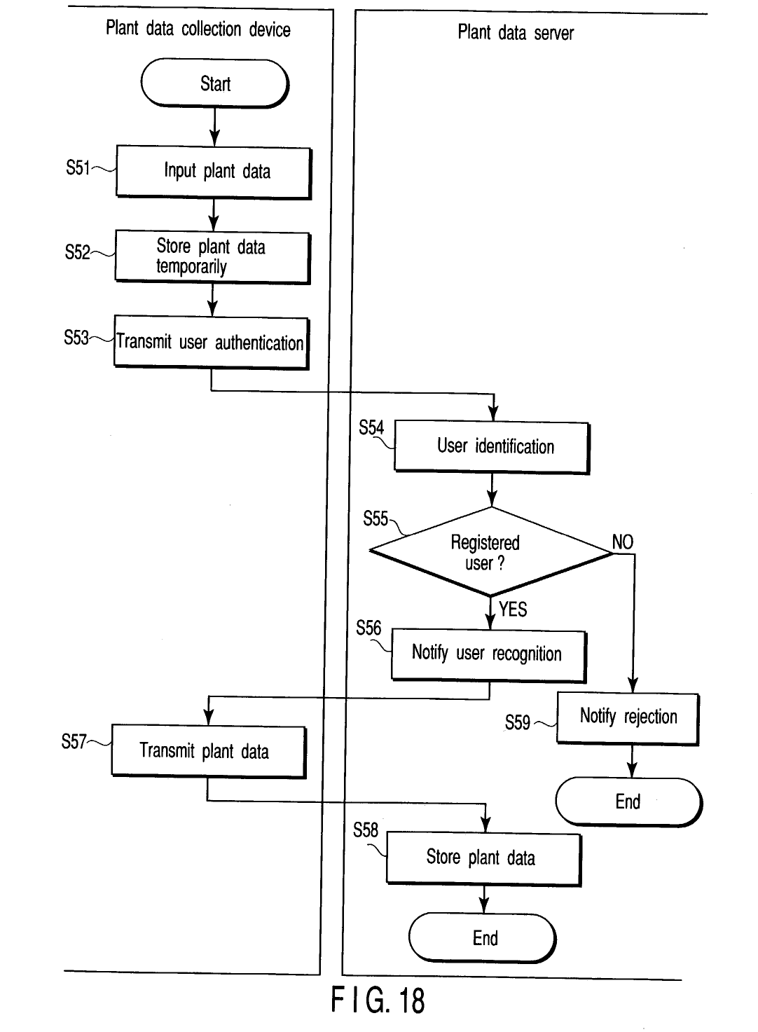

FIG. 18 is a flow chart schematically showing the plant data storing procedure from the time the plant data generated by the plant 4 is input to the plant data collection apparatus 105 to the time the plant data is stored in the plant data file 123 of plant data server 109.

As is shown in FIG. 18, in the plant data collection apparatus 105 of the site 101, plant data is input to the plant data collection section 111 at predetermined time intervals (S51). An input time is added to each data value of the input plant data and the plant data is temporarily stored in the plant data file 113 (S52). At a preset transmission time, the plant data collection apparatus 105 sends the user authentication including the user ID and apparatus ID stored in the user authentication file 114 from the data transmission/reception section 112 to the plant data server 109 of data center 102 via the communication network 103 (S53).

The user authentication transmitted from the data collection apparatus 5 is received by the data transmission/reception section 121 of the plant data server 109 and identified by the user identification section 126 of processing section 122 (S54). If the result of identification shows that the user indicated in the user authentication is the registered user registered in the user-related information file 24 (YES in S55), the plant data server 109 issues a user recognition notice to the plant data collection apparatus 105 (S56).

Upon receiving the user recognition notice, the plant data collection apparatus 105 sends the plant data, which has been temporarily stored in the plant data file 113, from the data transmission/reception section 112 to the plant data server 109 via the communication network 103 (S57). The plant data server 109 receives the plant data sent from the data collection apparatus 5 and stores the plant data in the plant data file 123 through the data search storage section 125 of processing section 122 (S58).

If the user is not the registered user (NO in S55), the plant data server 109 issues a notice of rejection and finishes the communication with the user (S59).

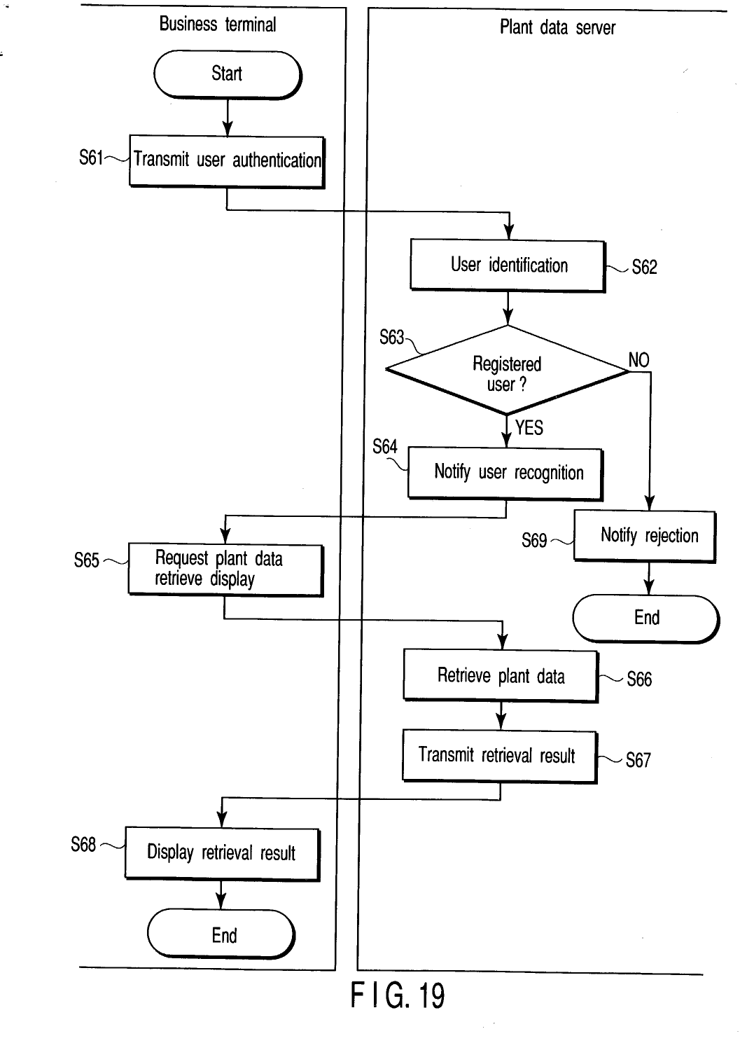

FIG. 19 is a flow chart schematically showing the plant data search/display procedure from the transmission of the user authentication from the business terminal 106 of the site 101 to the display of the plant data on the business terminal 106.

As is shown in FIG. 19, when the user of the site 101 sends a request for plant data search/display to the plant data server 109 of data center 102, the user authentication including the user ID, etc. is first transmitted from the data transmission/reception section 118 of the business terminal 106 to the plant data server 109 of data center 102 via the communication network 103 (S61).

The data transmission/reception section 121 of plant data server 109 receives the user authentication sent from the business terminal 106, and the user identification section 126 of processing section 122 identifies the user authentication (S62). If the result of identification shows that the user indicated in the user authentication is the registered user registered in the user-related information file 24 (YES in S63), the plant data server 109 issues a user recognition notice to the business terminal 106 (S64).

Upon receiving the user recognition notice, the business terminal 106 causes the input/output section 115 to display the user recognition notice through the input display section 116. The user confirms the displayed user recognition notice and inputs data search conditions through the input output section 115 and input display section 116 of the business terminal 106. In this case, the specific search conditions are the date/time of data generation and the point number uniquely added to each data item. The user ID (or apparatus ID) is added to these conditions to prepare a message of a plant data search/display request. The data transmission/reception section 118 transmits the plant data search/display request message to the plant data server 10 (S65).

Based on the search conditions in the plant data search/display request message sent from the business terminal 106, the plant data server 109 causes the data search storage section 125 of processing section 122 to search the plant data file 123 (S66). The data transmission/reception section 121 of plant data server 109 transmits the obtained search result data to the business terminal 106 via the communication network 103 (S67).

In the business terminal 106 that has received the search result data, the input display section 116 causes the input/output section 115 to display the search result data (S68). Thereby, the user confirms the displayed search result data, outputs the data, where necessary, to the printer apparatus 107 through the output section 117, and prints out the data in the form of a search result data sheet.

If the user is not the registered user (NO in S63), the print data server 109 issues a notice of rejection and finishes the communication with the user (S69).

As has been described above, in the present embodiment, the plant data server 109 timely transmits the search result data in response to the user's search/display request, and the data can be displayed on the user's business terminal 106. Accordingly, it is possible that the user-related information file 24 may store in advance plant journal information, such as data items of a plant journal and the order of data items, as part of service information to be provided to the user, or the user may send such plant journal information along with the search display request. Thereby, based on such plant journal information, the processing section 122 of plant data server 109 can mechanically prepare report data of the plant journal and can cause the user's business terminal 106 to display such data.

As has been described above, according to the system of the present embodiment, the plant data of the site 101 can be instantaneously sent from the plant data collection apparatus 105 of site 101 to the plant data server 109 of data center 102 via the communication network 103. In addition, the transmitted plant data can be properly managed in the plant data server 109 on the basis of the user information and the information such as apparatus ID and user ID.

Accordingly, unlike the prior art, there is no need to provide a data server for each site. The single plant data server 109 provided in the data center 102 can instantaneously manage the plant data of a plurality of remotely positioned user's sites 101. Thus, only by inputting the plant data search/display request on the business terminal 106, the user can make the business terminal 106 instantaneously display the content of the plant data managed by the plant data server 109 and can confirm the content.

In particular, in the present embodiment, the provision of services such as preparation of a plant journal by the data center 102 can timely be realized. In addition, the user is not required to perform data back-up, management of the data server, provision of space for installation of the data server, estimation of cost for repair and periodical replacement of parts and electricity, and provision of uninterruptible power supply. Therefore, the cost and labor on the user side can be reduced.

In the sixth embodiment, for the purpose of simple description, the plant data and the plant data search/display request are transmitted after the user authentication in both the plant data storing procedure and the plant data search/display procedure. In the actual operation, in general cases, the plant data collection apparatus 105 transmits the plant data as whole transmission information including user authentication information. If the user authentication added to the plant data determines that the user is not the registered user, the plant data along with a notice of rejection is sent back.

In the plant data search/display procedure, the user authentication can be effected using a card storing “user ID” and “apparatus ID” and a card reader.

In the sixth embodiment, the user ID and apparatus ID that specify the plant data collection apparatus 105 are stored in advance in the user authentication file 114 of the plant data collection apparatus 105 and the user-related information file 24 of the plant data server 109. However, in the actual operation, in general cases, the user ID and apparatus ID are issued to the user on the plant data server 109 side after the completion of the registration of the user. Specifically, the processing section 122 of the plant data server 109 is provided with the function of outputting such user ID and apparatus ID, and it outputs the user ID and apparatus ID and stores them in the server. In addition, the issued user ID and apparatus ID are told to the user, and the user inputs them in the plant data collection apparatus 105 and business terminal 106.

In particular, the user is not familiar with the data collection apparatus. Thus, if the apparatus ID is reported directly or indirectly to the management staff of the data collection apparatus and this management staff sets the apparatus ID or the user sets the apparatus ID by the guidance of the management staff, the labor of the user is greatly reduced. Therefore, this will contribute, along with the advantage of the first embodiment, to the development of the data management/service business.

The connection between the user of the site and the management staff of the data collection apparatus is relatively strong. In view of this, when the business is to be developed in a wider field, it is possible that the user-specifying information such as the user name and address and the service information to be provided to the user may be reported to a storage manager via the data collection apparatus management staff. Thereby, the labor of the user and the storage manager can further be reduced.

The data collection apparatus is not limited to a stationary one, and it may be a portable one. For example, a plant operator may carry a portable data collection apparatus while going the round, and may send data of each equipment to the data server. In this case, wireless communication may advantageously be performed between the data collection apparatus and the data server.

On the other hand, the data collection apparatus and the user's business terminal may not be separated. An integrated apparatus comprising them may be used. If such an integrated data collection/business terminal is used, data may be transmitted to the data server while data in the data server may easily be confirmed or corrected in parallel. Furthermore, data may be confirmed or corrected before it is transmitted.

The present invention relates to evaluation of a money-saving effect for plants.

What is claimed is:

1. A money saving service method for subjecting a client's plant to a money saving measure and providing money saving effect information to the client via a communication network using a data server, comprising:
a step of storing, in a data accumulation section of the data server on a client-by-client basis, customer-related information including information that specifies the client, apparatus identification information that can specify a data collection apparatus disposed in a plant belonging to the client, and money saving evaluation information for calculating a money saving effect on the basis of pre-measure cost and post-measure cost information;
a step of storing input cost information before a money saving measure in the data accumulation section on a client-by-client basis;
a step of adding the apparatus identification information to plant data of the client after the money saving measure, which is collected in the data collection apparatus, and receiving the plant data with the apparatus identification information via the communication network;
a step of calculating post-measure cost information using the received plant data and the client-related information stored in the data accumulation section, and storing the post-measure cost information in the data accumulation section; and
a step of extracting money saving evaluation information associated with the client by referring to the post-measure cost information stored in the data accumulation section, and calculating the money saving effect on the basis of the extracted information and transmitting the money saving effect to a client business terminal.

2. A money saving service method according to claim 1, comprising:
a step of adjusting a formula for evaluating money saving between a client and a business owner and inputting the formula to money saving evaluation processing means for performing money saving evaluation based on predetermined evaluation information; and
a step of calculating a money saving amount within a predetermined time period using the money saving evaluation means on the basis of plant data and information other than the plant data relating to money saving.

3. A money saving service method according to claim 1, further comprising:
a step of finding twin plants X and Y capable of obtaining the same electric load and the same thermal load in order to evaluate an effect of a money saving measure, one of the plants being subjected to a money saving measure while the other plant being not subjected to a money saving measure; and
a step of calculating, with use of a money saving evaluation apparatus for receiving data of the twin plants and performing money saving evaluation, a money saving amount by subtracting, in general cases, a plant running cost of the plant subjected to the money saving measure from a plant running cost of the plant not subjected to the money saving measure.

4. A money saving service method according to claim 1, further comprising:
a step of verifying a money saving evaluation method for a given plant on an actual plant that is evaluated by an evaluation method using data of twin plants; and
a step of readjusting evaluation information of a money saving evaluation apparatus on the basis of a result of the verification.

5. A money saving service method according to claim 1, wherein the data accumulation means accumulates a process value and information other than plant data.

6. A money saving service method according to claim 1, wherein a first communication apparatus disposed on a plant side and a second communication apparatus disposed on a remote side are connected over a communication line, and the first communication apparatus and the second communication apparatus cooperate with each other.

7. A money saving service method according to claim 1, wherein a money saving effect amount is calculated at predetermined intervals as a money saving evaluation result, and a report on the money saving effect amount is output.

8. A money saving service method according to claim 1, further comprising:
a step of storing money saving effect information in the data server; and
a step wherein at least one of the client and a money saving service provider inspects information in the data server.

9. A money saving service method according to claim 8, further comprising a step of displaying a money saving effect amount obtained at predetermined intervals as a money saving evaluation result.

10. A money saving service method according to claim 8, wherein said step of inspecting the information of the data server further includes a step of performing communication between the client and the money saving service provider, and a step of storing a result of the communication.

11. A money saving service method according to claim 1, further comprising a step of prompting the client to input an ID and a password when the client inspects a web page on the data server, in order to permit only a pre-registered client to inspect the web page.

12. A money saving service method according to claim 1, further comprising:
a step of prompting the client to input confirmation by presenting confirmation information relating to the money saving evaluation information;
a step of subjecting the client's plant to a money saving measure on condition that the confirmation has been input;
a step of storing input pre-measure cost information;
a step of receiving and storing plant data sent from a transmission apparatus that collects the client's post-measure plant data;
a step of calculating the post-measure cost information using the stored plant data;
a step of calculating a money saving effect on the basis of the calculated post-measure cost information, the stored pre-measure cost information and the money saving evaluation information; and
a step of providing the client with the money saving effect information based on the calculated money saving effect.

13. A money saving service method according to claim 11 or claim 12, comprising a step of obtaining pre-measure cost information, as said pre-measure cost information, by operating the plant in a pre-measure state for a predetermined time period.

14. A money saving service method according to claim 1, further comprising:
a step of storing a pre-measure cost calculation condition for calculating pre-measure cost information based on post-measure plant data;
a step of prompting the client to input confirmation by presenting confirmation information relating to the money saving evaluation information and the pre-measure cost calculation condition;
a step of receiving and storing, after the input of the confirmation, plant data sent from a transmission apparatus that collects the client's post-measure plant data;
a step of calculating the post-measure cost information using the stored plant data, and calculating pre-measure cost information using said data and the pre-measure cost calculation condition;
a step of calculating a money saving effect on the basis of the calculated post-measure cost information, the pre-measure cost information and the money saving evaluation information; and
a step of providing the client with the money saving effect information based on the calculated money saving effect.

15. A money saving service method according to any one of claims 12 to 14, comprising:
a step of enabling input of change request information with respect to at least one of the money saving evaluation information and the pre-measure cost calculation condition, when the confirmation information is presented to prompt the input of the confirmation; and
a step of changing the stored information on the basis of the change request information when the client has input the change request information.

16. A money saving service method according to any one of claims 11 to 15, comprising a step of billing, when a positive effect is obtained as a result of the calculation of the money saving effect, in accordance with said effect.

17. A money saving service method according to claim 1, comprising:
a step of sending plant data to a network;
a step of inputting the plant data to a data server and processing/outputting money saving evaluation;
a step of providing a network terminal that displays a result processed by the data server; and
a step of performing input/change of information and an evaluation formula through the network terminal.

18. A money saving service providing apparatus for subjecting a client's plant to a money saving measure and providing money saving effect information to the client via a communication network using a data server, comprising:
means for storing, in a data accumulation section of the data server on a client-by-client basis, customer-related information including information that specifies the client, apparatus identification information that can specify a data collection apparatus disposed in a plant belonging to the client, and money saving evaluation information for calculating a money saving effect on the basis of pre-measure cost and post-measure cost information;
means for storing input cost information before a money saving measure in the data accumulation section on a client-by-client basis;
means for adding the apparatus identification information to plant data of the client after the money saving measure, which is collected in the data collection apparatus, and receiving the plant data with the apparatus identification information via the communication network;
means for calculating post-measure cost information using the received plant data and the client-related information stored in the data accumulation section, and storing the post-measure cost information in the data accumulation section; and
means for extracting money saving evaluation information associated with the client by referring to the post-measure cost information stored in the data accumulation section, and calculating the money saving effect on the basis of the extracted information and transmitting the money saving effect to a client business terminal.
